(19) United States
(12) Patent Application Publication
(10) Pub. No.: US 2026/0045594 A1
(43) Pub. Date: Feb. 12, 2026

(54) ENERGY STORAGE SYSTEM WITH IMPROVED THERMAL AND ELECTRICAL ISOLATING PROPERTIES

(71) Applicant: Magna Powertrain Inc., Aurora (CA)

(72) Inventor: Thorsten Sauer, Aurora (CA)

(21) Appl. No.: 19/102,894

(22) PCT Filed: Aug. 14, 2023
(86) PCT No.: PCT/CA2023/051077

§ 371 Date: Feb. 11, 2025

Related U.S. Application Data
(60) Provisional application No. 63/397,902, filed on Aug. 15, 2022.
(60) Provisional application No. 63/399,235, filed on Aug. 19, 2022.

(51) Int. Cl. H01M 10/658; H01M 50/209; H01M 50/249; H01M 50/258; H01M 50/593; H01M 50/595

(52) U.S. Cl. CPC H01M 10/658; H01M 50/209; H01M 50/258; H01M 50/593; H01M 50/595; H01M 50/249; H01M 2200/10

(57) ABSTRACT

An energy storage system includes an enclosure in which battery sub-modules are disposed. The sub-modules include a plurality of battery cells housed within a cell surround component. The cell surround is in the form of a bent sheet of material, and provides thermal isolation relative to adjacent sub-modules and electrical isolation in areas of concern for electrical shorts. The cell surround includes a side face and bottom face that extend between front and rear edges. The cell surround may be a multi-material construction with a central portion of conductive material and mica material disposed at the front and rear edges. The side face thermally isolates via an insulating pad or a plate of mica material. The cell surround may also be a single sheet of conductive material with electrically insulating tape disposed over the front and rear edges.

### CROSS-REFERENCE TO RELATED APPLICATIONS

The present application is a PCT International Application, and claims the benefit of previously filed U.S. Provisional Patent Application No. 63/397,902, filed Aug. 15, 2022 and U.S. Provisional Patent Application No. 63/399,235, filed Aug. 19, 2022, the entire contents of which are hereby incorporated by reference in their entirety.

### FIELD

The present disclosure is generally related to battery pack or energy storage systems, more particularly, to designs and methods to provide cost effective and robust high temperature electrically isolated components. These designs and methods can be implemented in any applications where electrical current isolation or resistance to high temperatures is required related to battery or other electric systems. An alternative material component and an alternative multi-material component internal to the battery pack are disclosed, as well as a protective tape providing puncture and dielectric resistance.

### BACKGROUND

This section provides background information related to the present disclosure which is not necessarily prior art.

The present disclosure generally relates to components in high voltage energy storage systems utilized in electric or hybrid automobiles. The energy storage system enclosure includes an arrangement of multiple battery submodules made of numerous cells and is positioned under or around the passenger compartment of the vehicle. The batteries, possibly all battery cells together or in individual modules, are located in an enclosure for protection from the external environment as well as to protect passengers in the vehicle, as lithium-ion type batteries can be unstable due to the types of chemistries utilized.

Battery chemistry and related components and methods can apply to different battery chemistry types including, but not limited to, sodium ion, iron-air, or nickel-metal hydride batteries. As lithium ion batteries have high voltage around 400-800V, high energy density, and can potentially suffer from thermal runaway, one technique to provide for a safer system is to limit each battery sub-module to a small number of battery cells, typically less than 15 cells. Each of the battery sub-modules are installed in the energy storage system enclosure. The energy storage system enclosure has a bottom portion with surrounding sides and a cover portion to form a complete surround of multiple battery sub-modules when attached together.

Inside the energy storage system enclosure, each battery sub-module is further surrounded by a thin sub-module housing that surrounds the battery cells. The sub-module housing may be considered as a cell surround or binder clip. The sub-module housing could be formed of one or multiple cell surround components dependent on design. Other architectures and designs are possible for the sub-module housing, but each typically provides the following characteristics.

The housing is utilized as a safety system to prevent the spread of increasing temperatures during a thermal runaway event within the battery pack. The goal is to maintain any elevated temperatures at the cell or sub-module level, because if the increasing temperature spreads throughout the battery pack it may result in a dangerous condition to the vehicle and its occupants. Therefore, the housing must withstand up to 1000 Degrees C. Also, the housing is required to provide electrical isolation on surfaces which may come in contact with battery leads or within electrical connection areas to prevent an electrical short. An insulating member or insulating pad may also be applied to the cell surround, positioned between the cell surround and the battery cells to provide a lightweight, high-temperature thermal insulation and fire barrier engineered to mitigate thermal runaway propagation. This insulating pad is typically 2-3 mm thick and can be made of the commercially available material Aspen Aerogel PyroThin or other similar types of material. The cell surround is normally a very thin stamped component because it is not required to provide any structural support within the energy storage system, and is typically only used as a separator and in combination with a thermal insulator.

When the cell surround is made of an electrically conductive material, dielectric coating or tape is used in areas that can come in contact with battery leads and connection areas. Current cell surrounds utilize electrically conductive 306 stainless steel due the material's stability at very high temperatures. Therefore, the addition of dielectric coatings and/or tapes are required to be applied to ensure electric isolation. These current stainless steel cell surround designs are typically very thin, less than 1 millimeter, stampings with multiple bends, edges and corners.

It has been challenging to find a method to apply these dielectric coatings and tapes to these very narrow edges. Solutions such as spraying or dipping have not been successful and require additional capital, and results in wasted material when applied. Taping solutions also have challenges because at times the tape may not adequately bond to the cell surround, which results in tape lift at end of the tape which could become damaged during part handling, eliminating electrical isolation. Current insulating tapes used to provide electrical isolation are typically made with a polyvinylchloride (PVC) backing and a non-corrosive rubber-based adhesive. These tapes are very thin and often suffer from edge, corner and burr breakthrough issues when being applied. Moreover, efforts to remove sharp edges and burrs on the stamped product is not cost effective. Accordingly, this either results in an increased rework rate where the tape needs to be re-applied, or if not caught prior to assembly, can compromise the safety of the energy storage system.

Therefore, improvements can be made to cell surround housings requiring thermal insulation and electrical isolation.

### SUMMARY

It is an aspect of the present disclosure to provide to provide a cost effective and robust, high temperature resistance, electrically isolated component using an alternative material over current state of the art materials.

It is an aspect of the present disclosure to provide a cell surround design that reduces the portion made from conductive material by integrating a non-conducting high temperature resistant material to each end, at a width that maintains the same overall dimension and functionality of the baseline product without the need for taping or coating.

It is a related aspect of the present disclosure to provide a design which utilizes a mica material across an entire length of the cell surround housing on the vertical side face to provide electrical isolation and as an alternative to the separate insulation pad to eliminate the need for an additional insulating component.

It is a related aspect of the present disclosure to provide designs and methods that can be implemented in any applications where electrical current isolation or high temperature resistance is required related to battery or other electric systems.

It is a related aspect of the present disclosure to utilize a cell surround material which is not electrically conductive eliminating any additional processing steps.

It is a related aspect of the present disclosure to utilize a cell surround material that is as thin as current sheet metal systems and can be formed in a similar shape utilizing standard forming process of heat and pressure

It is a related aspect of the present disclosure to eliminate additional insulating material that is typically added to the cell surround to provide thermal insulation and fire barrier, resulting in the potential for more volume within the sub-module, which can be utilized to expand the energy capacity of the battery.

It is an aspect of the present disclosure to provide an alternative protective tape which provides increased puncture resistance while providing dielectric properties.

It is a related aspect of the present disclosure to provide a tape design with a layer that will limit or prevent breakthrough from sharp edges and burrs, combined with an additional layer that provides dielectric properties with minimum capacity of 7000 VDC performance

It is a related aspect of the present disclosure to provide a tape design which is flexible, prevents breakthrough of sharp features, has little to no shrinkage due to aging, and minimal elongation to prevent delamination

It is a related aspect of the present disclosure to provide a tape design that will meet the application's environmental and performance test requirements for adhesion, abrasion, flammability, and thermo-shock.

In accordance with these and other aspects, a cell surround is provided that is made of mica plate material, which is provided in sheet form with a thickness similar to the 306 stainless steel. In particular a commercially available material such as Pyrodox HP5 Phlogopite can be used. This mica plate material is not electrically conductive, provides significantly lower thermos-conductivity, and can withstand temperatures of 1000 Degree C. in an intermittent condition. The low thermal conductivity of the mica plate material (less than 0.5 W/mk perpendicular to the plane of the plate) makes it an excellent thermal insulator between cells. The density of the mica plate material is also about 3 times lower than stainless steel, resulting in a significant weight reduction. Structurally, in its final form, it is similar to sheet steel of a similar thickness and can be formed into the final desired shape using trimming, pressing or molding, and heating processing steps. Because the mica plate material is not electrically conductive, there is no need for additional processes to provide electrical isolation on surfaces that may come in contact with battery leads or within electrical connection areas to prevent an electrical short. Because the mica plate material provides high-temperature thermal insulation and functions as a fire barrier, which will mitigate thermal runaway propagation, further added insulation need not be included. Thus, the usable volume within the cell surround housing is increased, allowing for increased volume of the battery cells, thereby leading to increased energy capacity for the energy storage system.

In another aspect, a further alternative cell surround housing is provided as a multi-material construction, where a central portion of the cell surround is a conductive material such as stainless steel, with the end portions having a stiff nonconductive material such as mica plate material. In this approach, the cell surround housing functions again to prevent the spread of increasing temperatures during a thermal runaway event within the battery pack, and is dimensionally the same as the above solution, but provides an alternative construction which can be more cost effective than other embodiments. In this aspect, the multi-material cell surround housing utilizes traditional stainless steel for the main, central portion of the cell surround, but integrates a non-electrically conductive, high temperature resistant material only on the end portions where electrical isolation is required. In this aspect, the non-electrically conductive material is mica plate material in the form of strips or rectangular portions, which are connected with the conductive material of the central portion to create a single cell surround housing. In this aspect, an insulation pad may also be applied to the cell surround as in the baseline cell surround housing as previously described, if necessary, and may be attached to the conductive material of the central portion longitudinally between the mica plate material strips that are disposed at the longitudinal ends.

Additionally, in the case of the multi-material cell surround, because the mica plate material provides insulating properties similar to the insulating pad, a mica sheet may be extended across the entire length of the vertical side face, eliminating the use of three separate pieces along that face (two mica strips and the insulating member) and incorporating the functionality into a single mica piece covering the entire side surface of the cell surround and extending beyond the conductive material edges (of the conductive central portion) to provide electrical isolation at the front and rear edges.

In accordance with another aspect regarding an alternative protective tape for providing electrical isolation at the ends of the cell surround, a multilayer tape may comprise the following arrangement. In this aspect, a first adhesive layer, using rubber or acrylic based adhesives is provided. The first adhesive layer adheres the alternative protective tape component to the cell surround, and a second puncture resistant layer is provided onto the cell surround housing, made of highly durable thermoplastic elastomer or a textile material overlaid with tiny, hard guard plate-like structures in a specific pattern. Either of these materials of the second puncture resistant layer will prevent a burr or sharp edge of the cell surround housing from breaking through this second layer. A third layer of adhesive adheres a fourth dielectric layer to the puncture resistance layer. In one aspect, a puncture resistant layer of the proper characteristics may also provide dielectric properties sufficient to electrically isolate the component, as well.

In yet another aspect, an alternative protective tape is in the form of a single layer having the proper non-conductive dielectric properties as well as thermal resistance properties, but having an increased thickness relative to traditional protective tape. In this aspect, the protective tape may include an adhesive on one side that faces the cell surround housing, and which adheres the thick tape material to a side face of the cell surround housing. In this aspect, the protective tape is not necessarily puncture proof. However, the protective tape including the increased thickness has a thickness that is greater than a height of the burrs projecting outwardly from the cell surround housing. Thus, the protective tape has a maximum thickness measured between an inner and outer surface and a reduced thickness measured between the inner and outer surface, where the reduced thickness is disposed at the location of the burrs in response to the burrs projecting into the protective tape without projecting through the protective tape.

These and other features and advantages of the present invention will become more readily appreciated when considered in connection with the following detailed description and appending drawings.

### BRIEF DESCRIPTION OF THE DRAWINGS

The drawings described herein are for illustrative purposes only of selected embodiments and are not intended to limit the scope of the present disclosure. The inventive concepts associated with the present disclosure will be more readily understood by reference to the following description in combination with the accompanying drawings wherein.

FIG. 1 is an isometric sectional view of an energy storage system;

FIG. 2 is an isometric view of a cell surround made from sheet steel including an insulating pad with dielectric tape applied;

FIG. 3 is an isometric view of another cell surround made from a mica plate material;

FIG. 4 is a cross sectional view of an alternative protective tape construction;

FIG. 5 is an isometric view of a cell surround having a multi-material construction, including a central conductive portion and non-conductive portions disposed at each end extending beyond the central portion; and

FIG. 6 is an isometric view of a cell surround housing having a multi-material construction, including a conductive central portion having a bottom surface with non-conductive portions disposed at each end, and side portion extending upwardly form the bottom portion and including a non-conductive plate extending between the ends of the housing and beyond the ends of the of the central portion.

### DETAILED DESCRIPTION

Examples will now be described more fully with reference to the accompanying drawings. It is to be recognized the example embodiments only are provided so that this disclosure will be thorough, and will fully convey the scope, which is ultimately defined by the claims, to those who are skilled in the art. Numerous specific details are set forth, such as examples of specific components, devices, and methods, to provide a thorough understanding of embodiments of the present disclosure. It will be apparent to those skilled in the art that certain specific details need not be employed, that example embodiments may be embodied in many different forms, and that neither should be construed to limit the scope of the disclosure or the claims. In some example embodiments, well-understood processes, well-understood device structures, and well-understood technologies are not described in detail.

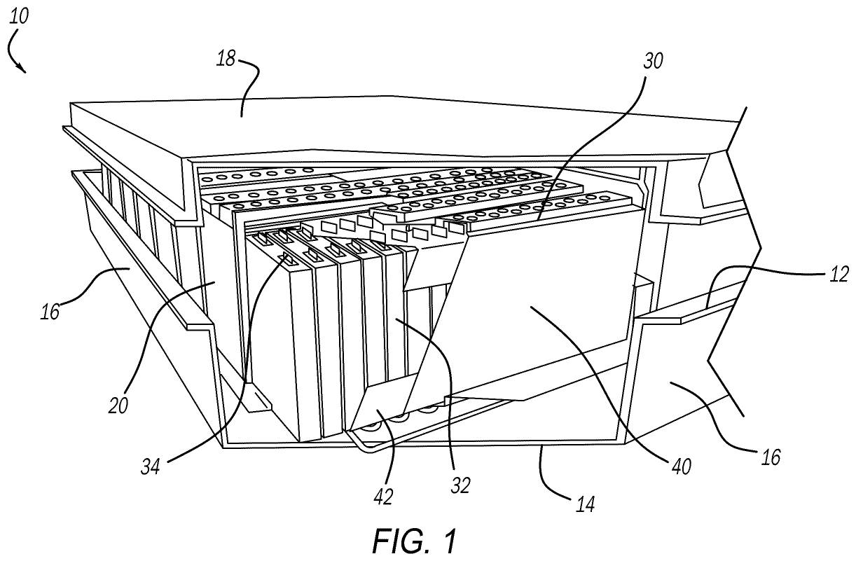

With reference to FIG. 1, a view of an energy storage system 10 is shown in a sectional view allowing the internal components to be seen. The energy storage system 10 includes a bottom housing 12 providing a bottom surface 14 and four side surfaces 16 extending vertically from the bottom surface 14 and a cover 18 that attaches to the bottom housing 12 to create an inner volume 20. Several battery sub-modules 30 are positioned in the inner volume 20 and secured within the energy storage system 10. The battery sub modules 30 include a multitude of individual battery cells 32. These battery cells 32 can be cylindrical, prismatic, or pouch structures. These battery cells 32 are tightly positioned together with battery leads 34 positioned and extending from one side of the cell arrangement to facilitate a connection together to provide power to an external connector of the energy storage system. A thin-walled cell surround component 40 encompasses the arrangement of battery cells 32 within the battery sub module 30 on various sides depending on the design. The purpose of this cell surround 40 is to provide a safety system to prevent the spread of increasing temperatures during the unlikely event of a thermal runaway within the energy storage system 10. The goal of the cell surround 40 is to contain any elevated temperatures to the localized region of the cell or sub-module, because if the increasing temperatures spread throughout the energy storage system 10 it can result in a dangerous condition to the vehicle and its occupants.

As can be seen in FIG. 1, the battery leads 34 or other electrical connection areas are in close proximity to the cell surround 40, therefore electrical isolation is required on surfaces which may come in contact with the leads to prevent an electrical short. An insulating member 42 may also be applied to the cell surround 40, positioned between the cell surround 40 and the battery cells 32 providing a lightweight, high-temperature thermal insulation and fire barrier engineered to mitigate thermal runaway propagation. This insulating member 42 is typically 2-3 mm thick. The cell surround 40 is normally a thin stamped component as it is not required to provide any structural support within the energy storage system 10, only used as a separator and thermal insulator. In the illustrated arrangement, the side surfaces of adjacent sub-modules 30, and corresponding cell surrounds 40, are disposed adjacent each other, with the bottom surfaces being free from interfacing with adjacent modules.

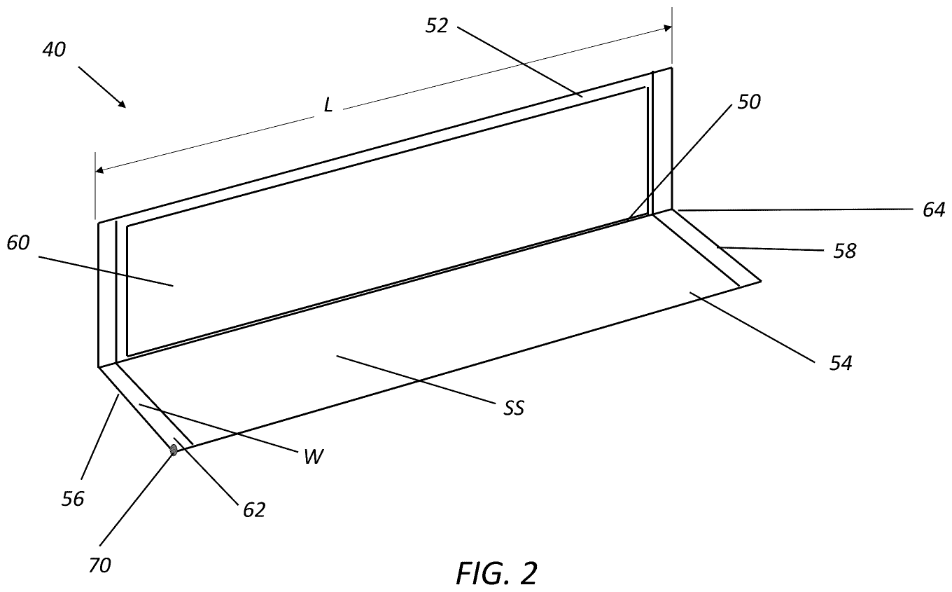

FIG. 2 shows a non-limiting example of a baseline version of a cell surround component 40 made from conductive material SS, such as stainless steel. The cell surround 40 can be various sizes and shapes, but in general is a multi-faced stamped component including flat face portions with approximately right angle bends 50. In this example, a side face 52 and a bottom face 54 are connected together with a bent portion 50 made from a single sheet of 306 grade stainless steel. As shown, the cell surround 40 has an L-shape. Each face has a front edge 56 and a rear edge 58, equivalent in thickness to the sheet steel material. In this design, a pair of L-shaped cell surrounds 40 can be used to further surround the battery cells 32. L-shapes can be positioned side-to-side in series, or they may be combined to face each other and create a U-shape. Or if required, a vertically positioned flat cell surround (not shown) could be used to further divide the space created by a pair of cell surrounds 40. Other cell surrounds could include a third face formed by a second bend to create a U-shape from a single sheet of bent material, or additional smaller faces extending from the front or rear edges 56,58 of cell surround 40.

Also, a multi-faced cell surround 40 could be used in conjunction with a further flat internal divider made from a nonconductive mica based material positioned between battery cells 32 for further separation and thermal propagation protection as needed. The aspects that will be further described can be utilized on any cell surround 40 design. In this particular example a stamped steel design with an insulation pad 60 (on the side face 52) and standard dielectric tape 62 (at the front and rear portions) is shown to describe the baseline design. Insulation pad 60 is adhered to side face 52 on the side facing and closest to battery cell 32.

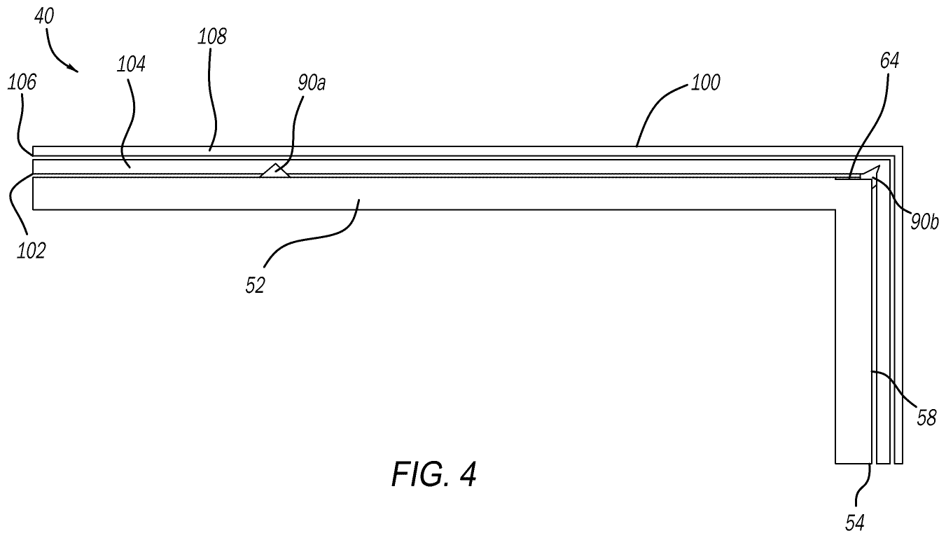

Continuing to refer to FIG. 2, details of the application of dielectric isolating tape 62 will be described. In this example, it is required that both the front and rear edges 56, 58 to be electrically isolated from potential electrical contacts. An application of a coating, either via spraying or dipping would be difficult to achieve along edges 56, 58 because it is a very thin cross section. The electrically isolated portion includes a portion of the side face 52 and bottom face 54 from the edge 56 or 58 inward towards the center to a specified width W, based on the protection required along these faces 52, 54 at each edge and the width of the tape 62. Although utilizing the dielectric tape 62 is effective, there are also concerns that there may be a breakthrough 70 of the edges 56, 58 through the tape 62 (shown in an example location of concern, but in the preferred embodiment does not breakthrough), especially at the corner 64 where faces 52 and 54 intersect at edges 56 and 58. A breakthrough 70 is defined as where there may be a burr or sharp edge which cuts into and through the dielectric isolation tape 62, resulting in a small portion of the conductive cell surround 40 surface being exposed through the tape 62 (for example, not covered by the tape). Any sized gap or breakthrough 70 of the tape 62 can allow current to be passed thru the air gap between the battery cell lead 34 and the cell surround 40, resulting in a short. Therefore, the improved tape of the present disclosure can be used to overcome these challenges, as described in further detail herein. In the embodiment shown in FIG. 2, it will be appreciated that the tape 62 may be a single material layer of tape with an adhesive layer bonding the tape to the cell surround 40, with the tape having an increased thickness or alternative puncture resistance to prevent breakthrough and provide electrical isolation. A multi-layer tape 100 is shown in further detail with reference to FIG. 4, and can be applied in a similar fashion to a conductive cell surround 40 as that which is illustrated in FIG. 2.

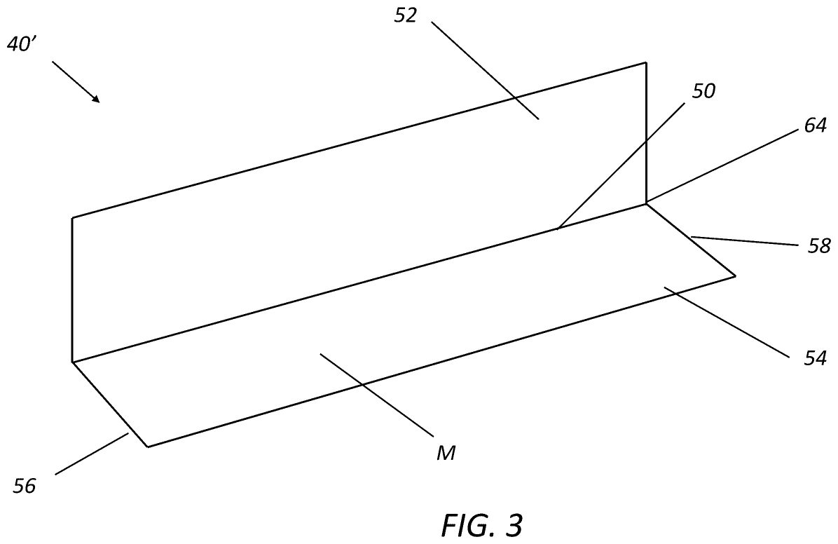

Referring now to FIG. 3, an alternative cell surround 40′ is shown made of mica material M. Cell surround 40′ has the same thickness and dimensions as cell surround 40, but because the mica material M is not conductive there are no concerns of ensuring electrical current isolation between the cell surround 40′ and sources of energy such as the battery lead 34. The use of mica material allows for the reduction of secondary operations to maintain electrical isolation, including the reduction of any coating, spraying, or application of the dielectric isolating tape 62 as described earlier. Due to the greatly improved thermal properties of mica material, elimination of insulation pad 60 is also achieved. With the removal of the need for the insulation pad 60, additional space equivalent to the thickness of insulating pad 60 is gained on the cell side of the side face 52 of cell surround 40′. This additional space translates into the potential to package a wider battery cell 32. Because this additional space can be achieved in each battery sub-module 30, the overall energy capacity of energy storage system 10 can be increased. Also the elimination of insulating pad 60 reduces costs and assembly time. Mica material M is received as a flexible material, and the sheet is trimmed to final dimensions, heat applied, and pressure utilized in press to form the material into rigid structure out of a tool and into end shape form.

Referring to FIG. 4, in another aspect and with reference back to the baseline cell surround 40 of FIG. 2, an end view is shown of an improved protective tape 100 which provides increased puncture resistance while providing dielectric properties adhered to the cell surround 40 that is made from the electrically conductive material SS of FIG. 2. For simplicity, improved protective tape 100 is shown in cross-section looking from the rear edge 58 toward the front 56, as an example to be covering only the external edges 58 of cell surround 40. It would be understood that the improved protective tape 100 would be applied around all edges 56, 58 and faces 52, 54 as described and shown in FIG. 2. Put another way, it would also be disposed on the inner cell-side surface of side face 52 and bottom face 54. On the rear edge 58 along side face 52, shown in FIG. 4, an example burr 90a is shown protruding from the rear edge 58 edge and outwards. An additional burr or sharp edge 90b is located at corner 64. It should be understood these burrs may be present and extend from cell surround 40 at any location, in any position, and extending from on any edge of face of cell surround 40.

Continuing to refer to FIG. 4, each layer shown of improved protective tape 100 will be described in further detail. First layer 102 is an adhesive layer, using rubber or acrylic based adhesives. The first adhesive layer 102 would adhere fully around edges 56, 58 and onto both the outer and cell-side of the faces 52, 54, connecting puncture resistant layer 104 (which may also be referred to as a second layer in addition to the adhesive layer being the first layer) to cell surround 40. The first adhesive layer 102, in one approach, has a thickness of about 40 microns. The puncture resistant layer 104 is made of highly durable thermoplastic elastomer or a textile material overlaid with tiny, hard guard plate like structures in a specific pattern. The guard plate structures may be optimized in location on the tape to coincide with known sharp features of cell surround 40 or may be uniform across the surface of the tape. These puncture resistant materials will prevent a burr 90a, or sharp edge 90b seen in corner 64 from breaking through the puncture resistant layer 104 by either absorbing the burr 90a, 90b within the material, due to the material being thick enough and giving way without the burr causing a breakthrough 70, or be strong enough to withstand a burr pushing on the layer 104 and displacing the outer layers accordingly without a breakthrough 70. A third layer 106 of adhesive would adhere the fourth, outer dielectric layer 108 to the puncture resistant layer 104. The third layer 106 of adhesive is preferably made as thin as possible. The dielectric fourth outer layer 108 may be a 80-90 micron dielectric layer with a minimum capacity of 7000 VDC performance to customer ASTM test spec.

In another aspect, the improved tape 100 may be limited to one of the dielectric layer 108 or the puncture resistant layer 104, with adhesive layer 102 adhering the layer 104 or 108 to the material of cell surround 40. For example, if a material providing puncture resistance also provides dielectric capabilities, the puncture resistant layer 104 may be the only layer, and third (adhesive) or fourth (dielectric) layers would not be required. Or, if the dielectric layer 108 has an increased thickness, such that it has a thickness greater than that of burrs 90a, 90b, etc., the puncture resistant layer 104 may be deleted, with adhesive layer 102 adhering the increased thickness dielectric layer 108 directly to the cell surround 40 without an intermediate puncture resistant layer. In this aspect, an additional adhesive layer would also not be necessary. When the dielectric layer 108 is provided with its increased thickness, the burr 90a, 90b may still penetrate and even partially cut into the dielectric layer 108, but the increased thickness will prevent breakthroughs and thereby still provide the necessary electrical isolation. The use of a single layer having both puncture resistance and dielectric properties is accordingly illustrated with reference to tape 62 illustrated in FIG. 2.

In the case of the improved tape 100, the tape 100 may still be provided at the same locations and width W, as described above, with thermal insulation provided by pad 60 on side face 52 as described previously. Insulating pad 60 is not shown in FIG. 4, because the cross section is taken through a location adjacent the rear edge 58 where the tape is present.

Thus, a puncture resistant layer of the proper characteristics could provide dielectric properties sufficient to electrically isolate the component as well. The improved protective tape 100 would ensure that a burr 90 could not puncture or tear thru the layers compromising the dielectric performance via a breakthrough 70 as experienced with standard dielectric tape 62. Similarly, a dielectric layer of the proper characteristics and thickness could provide puncture resistant properties sufficient to withstand burrs and sharp edges, thereby preventing breakthrough as experienced with standard dielectric tape 62.

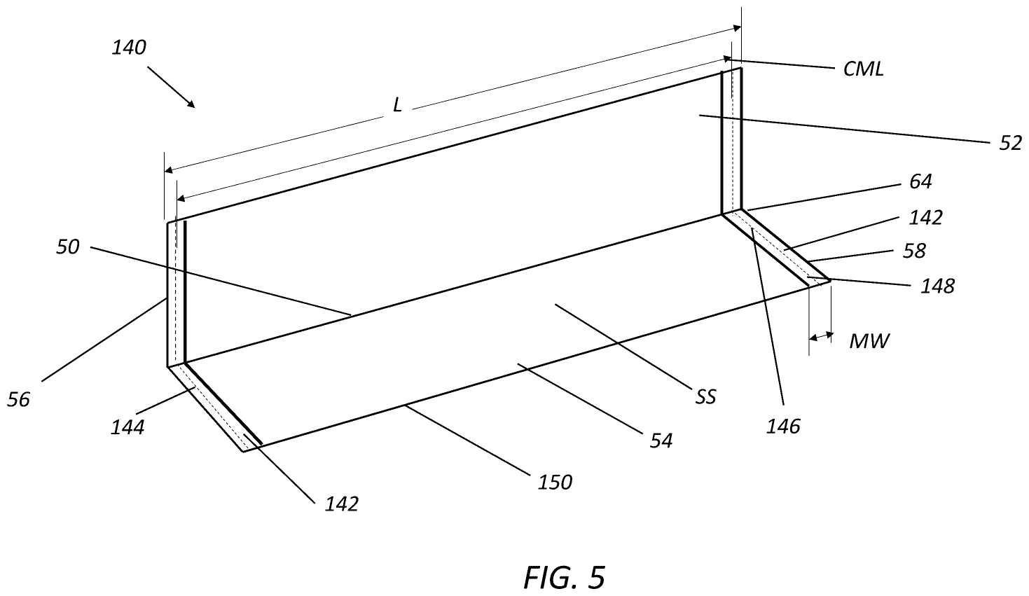

Referring to FIG. 5, an alternative cell surround 140 is shown in the form of a multi-material design, combining the baseline cell surround 40 material of stainless steel SS with strategically located areas of non-conductive material such as the mica material MM of cell surround 40′. To prevent the spread of increasing temperatures during a thermal runaway event within the battery pack, cell surround 140 must span a particular length to isolate volumes within energy storage system 10, requiring cell surround 140 to be the same length L and height as baseline cell surround 40. Length L (shown in FIG. 2) is defined as the distance from forward edge 56 to rear edge 58 of baseline surround 40.

As previously described, electrical isolation is required only on the end portions of the cell surround 40 at front and rear edges 56, 58. Accordingly, in baseline cell surround 40, tape 62 is applied to edges 56 and 58 (on both sides of the edges) with width W of tape 62 covering each end. Cell surround 140 provides an improved design, eliminating the requirement of taping or coating edges 56 and 58 as in baseline cell surround 40. Taping or coating increases costs due to additional processing, material, and potentially breakthrough issues if a standard thin tape is utilized. The alternative cell surround 40′ made entirely of mica material MM also provides the benefit of no taping, but can be higher cost and require different processing equipment and methods than implemented for a stainless steel cell surround component. Therefore, it can be beneficial to continue to utilize stainless steel for the main central portion of the cell surround 40, and to integrate a non-electrically conductive, high temperature resistant material only on the end portions which require isolation, as shown in alternative cell surround 140.

Continuing to refer to FIG. 5, cell surround 140 is modified by reducing the length of the conductive material portion SS of cell surround 140 (shown as conductive material length CML) and substituting mica material MM at the ends, in the form of multiple mica strips 142 added at the end portions to maintain the same overall length L as provided by cell surround 40. The mica material MM has a similar stiffness to the conductive material SS. The dimensions of conductive material length CML and the width MW of mica strip 142 are chosen to ensure an acceptable isolation between forward and rear edges 56 and 58 of the overall cell surround 140 and the conductive forward and rear edges 144 and 146 of the conductive material SS. These conductive forward and rear edges 144, 146 are disposed inward relative to the ultimate ends of the overall cell surround 140. This spacing of the conductive edges from the overall edges is achieved via an overlap 148 for attachment of the mica strip 142 to the conductive material SS. The dimensional relationship between the overall length L and conductive material length CML can be adjusted based on the width W of mica strip 142 and the required overlap 148 for attachment purposes, as long as the proper distance of electrical isolation is met.

The mica strip 142 can be made from commercially available mica based material such as Pyrodox HP5 Phlogopite and may have a thickness similar to the 306 stainless steel. In this design as shown, four rectangular mica strips 142 would be positioned on the cell side of bottom face 54 and side face 52 along each conductive edge 144 and 146. Using mica strip 142 as specifically labeled in FIG. 4 as an example, mica strip 142 is positioned on the upper surface of bottom face 54 with a portion of mica strip 142 width MW overlapping bottom face 54 and extending beyond forward conductive edge 144 to overall forward edge 56. Mica strip 142 is also positioned tightly towards bend 50 and along side face 52 in an overlapping manner such that it extends along the forward edge 56 along both the side face 52 and bottom face 54. In one aspect a single strip extends along both the side face 52 and the bottom face 54. In another aspect, two strips 142 are disposed at each end, with one being disposed on side face 52 and the other being disposed on the bottom face 54. Mica strip 142 may be flush or extend slightly over bottom face edge 150. Mica strip 142 is positioned so forward conductive edge 144 is parallel to the edge of the mica strip forming forward edge 56. This positioning ensures forward conductive edge 144 to be far enough away from battery leads or within electrical connection areas to prevent an electrical short, while providing the proper overall length L required for cell surround 140. Mica strips 142 are also provided at the rear conductive edge 146 in a similar overlapping manner along each of the side face 52 and bottom face 54.

Mica strip 142 is attached to conductive material SS in a fixed manner to maintain its position. This attachment method may be adhesive bonding or mechanical attachment, as long as it provides a rigid connection and remains durable in high temperature environments. In one aspect, a cyanoacrylate adhesive may be used, but an inorganic adhesive with even higher temperature resistance may be utilized such as highly heat-resistant silicone resin based adhesives. Although not shown, an insulating pad 60 as used in the baseline cell surround 40 may also be applied to the cell surround 140 as previously shown and described if required, positioned longitudinally between mica strips 142 on cell side of side face 52.

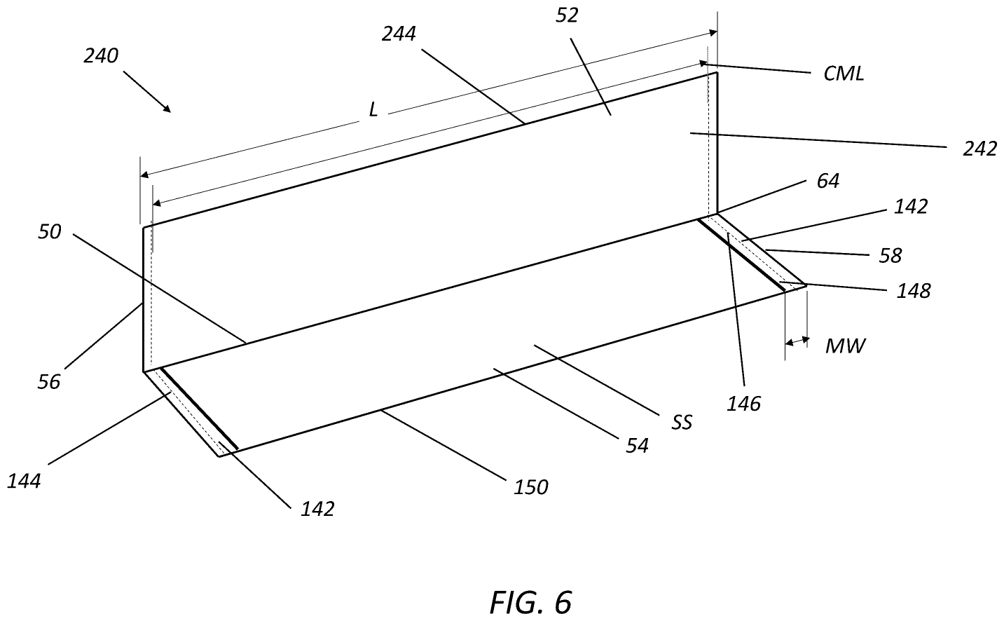

FIG. 6 provides another embodiment 240 of the multi-material design cell surround, where the mica strips 142 that were mounted towards the cells on side face 52 are replaced by a larger mica plate 242. Mica plate 242 provides dual functionality, providing electrical isolation to front and rear edges 56 and 58 as well as providing insulating properties between battery cell 32 and the side face 52 as previously provided by insulating pad 60. In this aspect, insulating pad 60 is not present. Mica plate 242 spans the entire length L, fully covering the conductive material SS forming side face 52 from bend 50 to front edge 56 to rear edge 58 and top edge 244. Mica strips 142 mounted to bottom face 54 are in the same configuration as described in the previously described embodiment 140 of the multi-material design. The attachment methods of the mica strips 142 to the conductive material SS would be applicable to attaching mica plate 242 as well. Therefore, second embodiment 240 of the multi material design cell surround includes a conductive material portion with a reduced length, two mica strips 142 mounted on the edge portions of bottom face 54, and a single larger mica plate 242 mounted to the side face 52 covering the entire side face surface without an additional insulating pad 60. Thus, in this embodiment, the material cost and assembling cost of fixing insulating pad 60 is eliminated, as well as eliminating the need to mount two mica strips 142, instead replaced by a larger mica plate 242 resulting in a more robust component.

In the above embodiments in which mica strips 142 are used, the previously described tape 62 or 100 is not included, thereby not being susceptible to potential burrs or the like. Electrical isolation is still provided by the non-conductive mica strips, with thermal insulation provided by either the insulating pad 60 or the mica plate disposed along the side face 52.

In one aspect, the same embodiment is used for each of the cell surrounds 40 provided to the sub-modules 30. However, it will be appreciated that due to the provided electrical isolation and thermal insulation by each of the embodiments, it is possible to combine multiple embodiments within the same system 10, with the thermal insulation and electrical isolation benefits being provided throughout, and without concern for breakthroughs 70.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varies in many ways. Such variations are not to be regarded as a departure from the disclosure, and all such modifications are intended to be included within the scope of disclosure.

What is claimed is:

1. An energy storage system comprising:
an enclosure including a bottom portion and a cover, wherein the enclosure is configured to hold and surround at least one battery sub-module, wherein the cover is sealingly attached to the bottom portion and defines an internal volume of the enclosure;
a plurality of battery cells disposed within each sub-module;
a cell surround component positioned around the battery cells, wherein the cell surround thermally insulates the battery cells of each sub-module to prevent a spread of increasing temperature beyond a localized area during a thermal runaway event;
wherein the cell surround is in the form of a bent sheet of material defining a bottom face and a side face, each extending longitudinally between a front edge and a rear edge of the cell surround and defining a bend between the side face and the bottom face, wherein the side face and the bottom face each have a cell side facing the battery cells and an outer side facing away from the battery cells;
wherein the side face thermally isolates the plurality of battery cells;
wherein the cell surround includes front and rear non-conductive portions disposed at least at the front edge and the rear edge, wherein the non-conductive portions extend longitudinally inward at an electrically insulating width from the front edge and the rear edge, respectively, such that an exposed conductive portion is not present within the electrically insulating width.

2. The energy storage system of claim 1, wherein the bent sheet of material is made of a conductive material, and the side face includes an insulation pad disposed on the cell side of the side face, and wherein the non-conductive portions include a tape disposed over both the cell side and the outer side around both the front edge and the rear edge, wherein the tape covers the electrically isolates the conductive material of the bent sheet of material.

3. The energy storage system of claim 2, wherein the bent sheet of material includes at least one projection of conductive material in the form of a burr or a sharp edge, wherein the projection extends into the tape, wherein the projection does not break through the tape and the non-conductive portions remain free of breakthroughs of conductive material.

4. The energy storage system of claim 3, wherein the projection is a sharp edge at a corner defined by an intersection of the side face and the bottom face at the front edge or the rear edge.

5. The energy storage system of claim 3, wherein the tape includes an adhesive layer and a dielectric layer, wherein the adhesive layer secures the dielectric layer relative to the bent sheet.

6. The energy storage system of claim 5, wherein the at least one projection has a height and the tape has a thickness greater than the height of the projection, wherein the projection penetrates the dielectric layer and dielectric layer remains disposed over the projection and electrically isolates the projection.

7. The energy storage system of claim 5, wherein the tape includes a puncture resistant layer disposed between the dielectric layer and the bent sheet, wherein the adhesive layer is disposed between the puncture resistant layer and the dielectric layer, and a further adhesive layer is disposed between the puncture resistant layer and the bent sheet, wherein the projection does not break through the puncture resistant layer.

8. An energy storage system comprising:
an enclosure including a bottom portion and a cover, wherein the enclosure is configured to hold and surround at least one battery sub-module, wherein the cover is sealingly attached to the bottom portion and defines an internal volume of the enclosure;
a plurality of battery cells disposed within each sub-module;
a cell surround component positioned around the battery cells, wherein the cell surround thermally insulates the battery cells of each sub-module to prevent a spread of increasing temperature beyond a localized area during a thermal runaway event;
wherein the cell surround is in the form of a bent sheet of material defining a bottom face and a side face, each extending longitudinally between a front edge and a rear edge of the cell surround and defining a bend between the side face and the bottom face, wherein the side face and the bottom face each have a cell side facing the battery cells and an outer side facing away from the battery cells;
wherein the side face thermally isolates the plurality of battery cells;
wherein the cell surround includes front and rear non-conductive portions disposed at least at the front edge and the rear edge, wherein the non-conductive portions extend longitudinally inward at an electrically insulating width from the front edge and the rear edge, respectively, such that an exposed conductive portion is not present within the electrically insulating width;
wherein the non-conductive portions are in the form of a non-conductive mica material.

9. The energy storage system of claim 8, wherein cell surround component is a multi-material component, wherein the bent sheet is made of a conductive material having a front conductive edge and a rear conductive edge, wherein the mica material extends longitudinally outward from each of the front conductive edge and rear conductive edge, wherein the mica material defines the front edge and the rear edge of the cell surround component.

10. The energy storage system of claim 9, wherein the conductive material defines a longitudinal conductive material length (CML), wherein the CML is less than an overall length of the cell surround component.

11. The energy storage system of claim 10, wherein the mica material longitudinally overlaps the conductive material at the front and rear conductive edges, respectively, wherein the mica material has a width greater than the electrically isolating width.

12. The energy storage system of claim 11, wherein the mica material is disposed on the cell side of the conductive material.

13. The energy storage system of claim 11, wherein the mica material is in the form of strips disposed at the front and rear conductive edges on the bottom face and the side face.

14. The energy storage system of claim 11, wherein the mica material is in the form of a plate of material extending fully between the front edge and the rear edge of the cell surround component along the side face, and further in the form of strips disposed at the front and rear conductive edges on the bottom face.

15. The energy storage system of claim 14, wherein the mica material thermally insulates the side face, wherein the side face does not include a further insulation pad.

16. The energy storage system of claim 13, further comprising an insulation pad extending longitudinally between the mica strips on the cell side of the side face.

17. The energy storage system of claim 13, wherein separate mica strips are disposed on the side face and the bottom face at each of the front and rear edges.

18. The energy storage system of claim 11, wherein the mica material is flush with or extends beyond a bottom face edge of the bottom face and is flush with or extends beyond a top edge of the side face.

19. The energy storage system of claim 18, wherein the separate strips of mica material contact each other at the bend between the side face and the bottom face.

20. An energy storage system comprising:
an enclosure including a bottom portion and a cover, wherein the enclosure is configured to hold and surround at least one battery sub-module, wherein the cover is sealingly attached to the bottom portion and defines an internal volume of the enclosure;
a plurality of battery cells disposed within each sub-module;
a cell surround component positioned around the battery cells, wherein the cell surround thermally insulates the battery cells along a thermal insulation length of each sub-module to prevent a spread of increasing temperature beyond a localized area during a thermal runaway event;
wherein the cell surround is in the form of a bent sheet of material defining a bottom face and a side face, each extending longitudinally between a front edge and a rear edge of the cell surround and defining a bend between the side face and the bottom face, wherein the side face and the bottom face each have a cell side facing the battery cells and an outer side facing away from the battery cells;
wherein the side face thermally isolates the plurality of battery cells along the thermal insulation length;
wherein the bent sheet is made of mica material, wherein the bent sheet is entirely non-conductive and thermally insulating, wherein the cell surround structure does not include a further insulation pad and the front and rear edges do not include further electrically isolating materials;
wherein the cell surround includes front and rear exposed portions disposed at least at the front edge and the rear edge, wherein the exposed portions extend longitudinally outward at an electrically insulating width from the battery cells to the front edge and the rear edge, respectively, such that the mica material is exposed and present longitudinally beyond the thermal insulation length and provides a non-conductive extension from the battery cells.
